(19) United States
(12) Patent Application Publication
(10) Pub. No.: US 2025/0043925 A1
(43) Pub. Date: Feb. 6, 2025

(54) SYSTEM AND METHOD FOR LOCATING THE SOURCE OF AN EMISSION OF GAS OR PARTICLES

(71) Applicant: IFP ENERGIES NOUVELLES, Rueil-Malmaison (FR)

(72) Inventors: Leo AGELAS, RUEIL-MALMAISON CEDEX (FR); Mongi BEN GAID, RUEIL-MALMAISON CEDEX (FR); Guillaume BERTHE, RUEIL-MALMAISON CEDEX (FR); Jean-Louis PAJON, RUEIL-MALMAISON CEDEX (FR); Abdallah BENALI, RUEIL-MALMAISON CEDEX (FR)

(21) Appl. No.: 18/714,128

(22) PCT Filed: Nov. 24, 2022
(86) PCT No.: PCT/EP2022/083076

§ 371 Date: May 29, 2024

(30) Foreign Application Priority Data
Dec. 7, 2021 (FR) FR2113054

(51) Int. Cl. F17D 5/02; F17D 5/00; G01M 3/04

(52) U.S. Cl. CPC F17D 5/02; F17D 5/005; G01M 3/04

(57) ABSTRACT

The present invention is a method for determining the position of a source emitting at least one of a gaseous compound and particles in a geographical area, comprising measuring the gaseous compound concentration, the wind direction and speed for different predefined consecutive geographical positions to deviate by at most 45° from an instantaneous or average wind direction. At least one pair of a consecutive minimum and maximum of the curve is subsequently determined, and the position of the emission source is determined from the positions of the mobile measurement system corresponding to the maxima of the pairs, the time gaps between the maximum and minimum of the pairs, and average wind speeds and directions between the minimum and maximum of the pairs.

### CROSS-REFERENCE TO RELATED APPLICATIONS

Reference is made to PCT/EP2022/083076 filed Nov. 24, 2022, and French Application No. 2113054, filed Dec. 7, 2021, which are incorporated herein by reference in their entirety.

### BACKGROUND OF THE INVENTION

### Field of the Invention

The present invention concerns at least one of gas leak monitoring and particle emission source monitoring in general, and more specifically monitoring leakage of a gas supplying or intended to supply gas distribution networks, such as natural gas or biomethane.

### Description of the Prior Art

Natural gas or biomethane leaks may occur by way of non-limitative example in storage sites of such gases (geological reservoirs or tanks for example), in gas transport facilities (high-pressure pipelines for gas transport over long distances for example), in gas distribution facilities (for example stations for injection into the distribution network, pipes allowing local distribution to various entities, individuals, businesses, etc.), or in facilities using such gases (for example gas-fired power plants, some chemical and petrochemical industries, domestic dwellings, etc.).

Natural gas is a fossil fuel having a mixture of gaseous hydrocarbons, methane being one of the main constituents thereof. After extraction from an underground reservoir, the gas is subjected to processing steps notably including gas condensate separation, deacidification and desulfurization. It is after such processing that the natural gas can be injected into the natural gas distribution network. Natural gas is made up of 95% methane (CH4), less than 4% ethane (C2H6) and nitrogen (N2), and less than 1% carbon dioxide (CO2) and propane (C3H8).

Biomethane results from the purification of a biogas, which is produced by the anaerobic decomposition of waste of organic origin, such as sewage sludge, agricultural waste, landfills. Biogas mainly is methane (40% to 70%), CO2 and water vapor, but it also contains impurities such as sulfur compounds (H2S, SO2, . . . ), siloxanes, halogenated compounds or VOCs (Volatile Organic Compounds). Biogas is therefore not directly exploitable. To be exploited, biogas requires scrubbing (or purification), notably in order to remove the carbon dioxide and the hydrogen sulfide, as well as the other impurities it contains. Biomethane that can be injected into a distribution network, generally the natural gas distribution network, is thus obtained.

Natural gas is odorless, highly explosive (5% to 15% in air) and lethal if inhaled at high concentrations. To detect possible leakage and to prevent explosion risks, the natural gas is artificially odorized prior to being injected into the transport network. The same applies to biomethane. This allows distinguishing whether gas emissions result from leaks, notably in order to generate an alarm, or are natural emissions. The odorant molecules used are historically mercaptans, such as ethane mercaptan (also known as ethanethiol or ethyl mercaptan), methane mercaptan (also known as methanethiol or methyl mercaptan). Nowadays, in particular in Europe, the tetrahydrothiophene molecule (also known as THT, of formula C4H8S) is the most commonly used molecule for odorizing gases intended to be distributed. THT is a colorless flammable liquid with a characteristic sulfur smell (it is an organic sulfur compound). Odorant products are injected in very small amounts (about 10 ppb) into the gas to be odorized.

In industrial and environmental gas monitoring, it is necessary to accurately measure abnormal gas concentrations and also to locate them in the environment. The challenge in locating the source. Indeed, many measurements are performed in ambient air, and the abnormal concentrations measured come from a gas source located several ten meters away from the measurement point. The evolution of this gas plume in the ambient air mainly depends on the meteorological conditions, notably on the wind intensity and direction.

The following documents are mentioned in the description hereafter:
C. Couillet: Dispersion Atmosphérique (Mécanismes et outils de calcul), rapport INERIS-DRA-2002-25427, 2002, https://www.ineris.fr/sites/ineris.fr/files/contribution/Documents/46web.pdf.
E. Demael and B. Carissimo: Comparative Evaluation of an Eulerian CFD and Gaussian Plume Models Based on Prairie Grass Dispersion Experiment, Journal of Applied Meteorology And Climatology, vol 47, 2008.
L. J. Klein, R. Muralidhar, F. J. Marianno, J. B. Chang, S. Lu, H. F. Hamann: Geospatial Internet of Things: Framework for Fugitive Methane Gas Leaks Monitoring, GIScience 2016.
P. Kumar, G. Broquet, C. Yver-Kwok, O. Laurent, S. Gichuki, C. Caldow, F. Cropley, T. Lauvaux, M. Ramonet, G. Berthe, F. Martin, O. Duclaux, C. Juery, C. Bouchet, and P. Ciais. Mobile Atmospheric Measurements and Local-Scale Inverse Estimation of the Location and Rates of Brief CH4 and CO2 Releases from Point Sources. Atmospheric Measurement Techniques, European Geosciences Union, 2021, 14 (9), pp. 5987-6003.

In general, chemistry-transport models allow describing the evolution of air pollutants or of particles (aerosols, gas, dusts) released into the atmosphere. This evolution is due to the transport of pollutants (particles, gas molecules) in the atmosphere by the wind, and to chemical reactions in which the pollutants participate. By estimating the concentrations of various pollutants, chemistry-transport models notably allow simulation of the air quality or to simulate a continuous release of particles.

Generally, the methods used to determine a gas leaking point after gas release to the atmosphere at a given flow rate are based on the solution of an inverse problem. A description of these methods can for example be found in the documents (Klein et al., 2016; Kumar et al., 2021). More precisely, for this inverse problem, one considers a spatial region of the site being studied wherein one can sense that the leaking point is located. This region is subsequently subdivided by a Cartesian grid made up of cells. Each node of the grid is then considered to be a potential leaking point. The inverse problem iteratively seeks the source flow at each node of the grid allowing to best explain (or, even better, to satisfy) (in the sense of the least squares for example) the concentration measurements. It is noted that, to solve the direct problem, these methods assume that the wind and the atmospheric conditions remain stationary over a sufficient period of time and that they are spatially homogeneous, which leads to a Gaussian plume model, as discussed in the document (Klein et al., 2016) for example. After solving the inverse problem, the flow at each node of the grid is obtained and the error produced at each node of the grid, allowing the position of the leaking point to be deduced, is determined from these flows. These methods have the drawback of being computing time consuming, all the more so since the grid is fine. Now, to obtain good source location accuracy, it is necessary to have a fine grid. Furthermore, these methods cannot find a position of the source outside the predefined Cartesian grid.

### SUMMARY OF THE INVENTION

The present invention allows these drawbacks to be overcome. More precisely, the present invention concerns a method implemented from concentration measurements performed by a mobile monitoring station. The method is inexpensive in terms of computing time and memory size, and allows reliable determination of or almost in real time, the location of the source of a gas and/or particle leak. Furthermore, the method according to the invention does not require presupposing a location for the emission source.

The invention is a method for determining the position of a source which emits at least one of a gaseous compound and particles in a geographical area, using a mobile measurement system comprising at least one sensor for measuring at least one of a concentration of the gaseous compound and the particles, and a sensor for measuring a wind speed and direction. The method according to the invention comprises at least the following steps:
a) measuring the concentration of at least one of the gaseous compound and the particles, the wind speed and the wind direction for a succession of positions of the mobile measurement system forming a travel path of the mobile measurement system in the geographical zone, each of the positions corresponding to a measurement time of the mobile measurement system, the positions of the succession of positions of the mobile measurement system being determined so that each of the segments between two consecutive positions of the succession of positions of the mobile measurement system forms an angle of between 45° and 135° with an instantaneous or average wind direction resulting from the measured wind direction, and obtaining a first curve representative of the evolution of the concentration for each of at least one of the gaseous compounds and the particles as a function of the measurement time of the mobile measurement system, and second and third curves respectively representative of the evolution of the wind speed and direction as a function of the measurement time of the mobile measurement system;
b) from predefined criteria, for each of the first curves, determining at least one pair of a consecutive minimum and maximum of the first curve, and for each of the pairs of each of the first curves, determining a position of the mobile measurement system corresponding to the maximum of the pair and a time gap between a measurement time of the mobile measurement system corresponding to the maximum of the pair and a measurement time of the mobile measurement system corresponding to the minimum of the pair; and
c) for each of at least one of the gaseous compound particles, determining the position of the emission source of the gaseous compound or the particles in the geographical zone from the positions of the mobile measurement system corresponding to the maximum of the pairs determined for the gaseous compound or the particles, the time gaps between the maximum and minimum of the pairs determined for the gaseous compound or the particles, and average wind speeds and directions between the measurement times of the mobile measurement system corresponding to the minimum and maximum of the pairs.

According to one implementation of the invention, the position x₀ of the source emitting a gaseous compound or particles can be determined with a formula of the type:

$${x}_{0} = \frac{{\sum }_{ne = 1}^{NE} ( {x}_{ne} - {λ}_{ne} \vec{{v}_{ne}} )}{NE}$$

where NE is the number of the pairs determined, xₙₑ is the position of the mobile measurement system along the path corresponding to the maximum of the pair ne, λₙₑ is the time gap between the maximum and minimum of the pair ne, and \vec{v}ₙₑ is a vector oriented in the average wind direction between the measurement times of the mobile measurement system corresponding to the minimum and maximum of the pair ne, whose norm is the average wind speed between the measurement times of the mobile measurement system corresponding to the minimum and maximum of the pair ne.

According to an implementation of the invention, the angle formed between the segment between the first and second positions of the pair of consecutive positions of the path and the wind direction measured for the first position of the pair or the average wind direction measured prior to step a) can range between 80° and 100°, and it is preferably 90°.

According to an implementation of the invention, at the end of step a), a Butterworth filter can be applied to at least one of the at least one first, second, and third curves, and steps b) and/or c) can be applied from the first, the second, and third filtered curves.

According to an implementation of the invention, the predefined criteria of the first curve can be formed from a first and a second threshold value S1ext and S2ext defined with formulas of the type:

$$S 1 ext = 0.01 * ( C max - C min ) / C max and$$

$$S 2 ext = 0.001 * ( C max - C min ) / C max$$

where Cmin and Cmax are global minima and maxima of the first curve respectively.

According to an implementation of the invention, all of the pairs consisting of a consecutive minimum and maximum of the first curve can be determined as follows:
i) browsing the N samples of the first curve until one of the samples n verifies the inequality as follows:

$$\vert C ( n ) - C ( n - 1 ) \vert < S 1 ext * C ( n ) and C ( n + 1 ) > C ( n ) * ( 1 + S 1 ext )$$

where C(n−1), C(n) and C(n+1) are respectively the concentration measured for sample n−1, sample n and sample n+1, and initializing a table nmin with the index n,
ii) continuing to browse the N samples of the first curve until one of the samples n verifies the inequality as follows:

$$C ( n ) > ( 1 + S 2 ext ) * C ( n + 1 )$$

and incrementing a table nmax with the index n,
iii) continuing to browse the N samples of the first curve until one of the samples n verifies the inequality as follows:

$$C ( n + 1 ) > ( 1 + S 2 ext ) * C ( n )$$

and incrementing the table nmin with the index n,
and repeating steps ii) and iii) by continuing to browse the N samples of the curve in order to determine all the NI pairs (nmin (i), nmax (i)) of the indices nmin (i) and nmax (i) of the samples corresponding to a minimum and a maximum of the first curve, with i ranging from 1 to NI.

According to an implementation of the invention, it is possible to only keep the NE pairs of a minimum followed by a maximum of the first curve for which C(nmax(i))>Cmin+0.05*(Cmax−Cmin), with i ranging from 1 to NI, with NE≤NI.

Furthermore, the invention concerns at least one of a computer program product downloadable from a communication network, or recorded on a computer-readable medium and processor executable, comprising program code instructions for carrying out at least steps b) and c) as described above, the program is executed on a computer.

### BRIEF DESCRIPTION OF THE DRAWINGS

Other features and advantages of the method according to the invention will be clear from reading the description hereafter of embodiments given by way of non-limitative example, with reference to the accompanying figures wherein:

FIG. 1 shows the geographical positions of a mobile measurement system moving along a travel path for an example of application of the method according to the invention,

FIG. 2A shows the evolution of a measured methane concentration as a function of time along the travel path of the mobile measurement system shown in FIG. 1,

FIG. 2B shows the evolution of a measured wind direction as a function of time along the travel path of the mobile measurement system shown in FIG. 1,

FIG. 2C shows the evolution of a measured wind speed as a function of time along the travel path of the mobile measurement system shown in FIG. 1,

FIG. 3 highlights minima of the curve of FIG. 2A determined with the method according to the invention, each minimum being followed by a maximum,

FIG. 4 shows a portion of FIG. 3 comprising at least one minimum followed by a maximum, and

FIG. 5 corresponds to FIG. 1, and it additionally shows the position of the gas leak source determined with the method according to the invention, as well as the real position of the gas emission source.

### DETAILED DESCRIPTION OF THE EMBODIMENTS

The present invention concerns a method for determining the position of a source emitting at least one of a gaseous compound and particles in a geographical zone. In other words, the method according to the invention aims to determine the position of the origin of a gas or particle leak in a geographical zone. According to an implementation of the invention, the position of the source emitting at least one of a gaseous compound and particles, resulting from the method of the invention, can be two or three-dimensional. The geographical zone of interest can for example comprise a portion of an industrial site generating at least one of gaseous and particulate pollutants.

According to the invention, the gaseous compound can be a gaseous hydrocarbon compound such as methane, ethane, butane, but the gaseous compound can also be carbon monoxide, carbon dioxide, hydrogen, or a gaseous compound used to odorize gases, such as tetrahydrothiophene (THT) or a mercaptan (ethane mercaptan or methane mercaptan for example). According to a particular implementation of the invention, the source whose position is sought can emit both methane and THT.

Particles are understood to be any solid or liquid body of dimension below 100 μm, possibly with a volatile phase that can be adsorbed on a solid phase. By way of non-limitative example, the particles according to the invention can correspond to soot particles, which are fine particles (micrometric, submicronic and nanometric) rich in PAH (polycyclic aromatic hydrocarbons), and to particles resulting from the abrasion of parts such as, for example, metal particles from brake pads, particles resulting from tire abrasion, but also pollens, etc. The particles according to the invention are carried by ambient air.

The method according to the invention is implemented by use of a mobile measurement system comprising a sensor for measuring at least one concentration of at least one of a gaseous compound and particles whose origin is to be located, and a sensor for measuring a wind speed and direction. A mobile measurement system is understood to be a measurement system adapted to be moved, the system itself comprising a moving device, or the system being on board a vehicle, such as a motor vehicle, a truck, a powered two-wheeler, or a drone, an airplane, etc.

Advantageously, the mobile measurement system used for the method according to the invention comprises a single sensor for measuring the concentration of gaseous compounds. Such a sensor is for example described in patent application EP-3,901,604. Notably, the system described in this application comprises an optical measurement system including at least:
at least one light source emitting a UV radiation and an IR radiation through the ambient air in a measurement zone,
a spectrometer likely to detect at least part of the UV radiation that has passed through the ambient air in the measurement zone, and to generate a digital signal of the light intensity depending on the wavelength of the part of the UV radiation,
an IR detector likely to detect at least part of the IR radiation that has passed through the ambient air in the measurement zone, and to generate a digital signal of the light intensity depending on the wavelength of the part of the IR radiation.

In addition, the system described in this application further comprises devices for processing and analyzing the digital signal(s) (using a computer such as a microprocessor for example) in order to at least one of detect and characterize a gas leak from the digital signal(s) according to a method described in this application. More precisely, the method described in patent application EP-3,901,604 is from the emission, by a light source, of a UV radiation and an IR radiation, and using a UV spectrometer and an IR detector, a digital signal of the wavelength-dependent light intensity is generated, and at least the concentrations of methane and of the odorant chemical species are estimated from at least the digital signal. A gas leak is detected and characterized by at least a comparison of the methane concentration with a first threshold and a comparison of the odorant chemical species concentration with a second threshold.

Such a system and such a method allow quantifying in the ambient air, simultaneously and in real time, all the adsorbent gas molecules in the ultraviolet and the infrared. Notably, such a measurement system and such a method are suitable for measuring a methane and THT concentration.

According to an implementation of the invention, the sensor for measuring the wind speed and direction can be a weather station.

According to an implementation of the invention, the sensor for measuring a particle concentration can be the sensor described in WO-2021/170,413 A1.

The method according to the invention comprises at least steps 1) to 3) described hereafter, step 4) being optional.

### 1) Concentration and Wind Characteristics Measurements

According to the invention, the concentration of at least one of a gaseous compound and particles, as well as the wind speed and direction, are measured for a succession of positions of the mobile measurement system forming a travel path of the mobile measurement system in the geographical zone.

According to the method of the invention, it is not necessary for the path along which the measurements are performed to pass through the position of at least one of the source emitting the gaseous compound and the particles. On the other hand, it is obvious that the path according to the invention needs to pass at least once through the plume generated by the source emitting at least one of the gaseous compound and the particles of interest. Preferably, the path according to the invention can pass several times through the plume generated by the source emitting at least one of the gaseous compound and the particles of interest, in order to benefit from a redundancy of information relating to the position of the emission source, as discussed in step 3) below. Advantageously, a concentration measurement can be carried out for at least one of gaseous compounds and/or for a plurality of particles.

According to the invention, the succession of positions of the mobile measurement system is determined in such a way that each segment between two consecutive positions of the succession of positions of the mobile measurement system forms an angle ranging between 45° and 135° with an instantaneous or average wind direction obtained from the measured wind direction. In other words, the succession of positions of the mobile measurement system is determined in such a way that, for each pair of consecutive positions comprising a first and a second position, a segment between the first and the second position of the pair considered forms an angle ranging between 45° and 135°:
alternative 1: with the wind direction measured for the first position of the pair, or
alternative 2: with an average wind direction, determined from previously measured wind directions.

In other words, in the case of the first alternative, the path of the mobile measurement system is determined in real time, as a function of the wind direction measured in each position, and in order to determine the next position of the mobile measurement system. This is referred to as instantaneous wind direction. In the case of the second alternative, the path of the mobile measurement system is determined from a previous measurement of the average wind direction, which can be performed before carrying out step a), or while carrying out step a), for example consecutive positions of the mobile measurement system prior to the second position.

Thus, in general, the mobile measurement system used for the method according to the invention moves along a path whose segments between two consecutive positions form an angle ranging between 45° and 135° with an (instantaneous or average) wind direction. Such a path allows consideration of at least one of the curve measuring over time the gaseous compound and particle concentrations is Gaussian shaped (if the path passes through the gas or particles plume only once) or that it is a plurality of Gaussian shaped curves (if the path passes several times through the gas or particles plume). Indeed, in general, assuming that the wind and the weather conditions are stationary over the duration of the measurement, if gaseous compound or particles concentrations are measured while passing through a gas or particle plume in a substantially perpendicular manner, it can be shown that the shape of the measured concentration curve is a Gaussian, as discussed for example in the documents (Couillet, 2002; Demael and Carissimo, 2008). However, it may be difficult or even impossible, due for example to the presence of obstacles in the geographical zone to be explored, to maintain in real time a position of the mobile measurement system perfectly perpendicular to the instantaneous wind direction. Thus, according to the invention, it is considered as a first approximation that the curve measuring a gaseous compound or particles concentration is generally Gaussian shaped when deviating by up to 45° from the direction perpendicular to the wind.

Advantageously, the mobile measurement system used for the method according to the invention moves along a path whose segments between two consecutive positions form an angle ranging between 80° and 100°, preferably 90°, with the (instantaneous or average) wind direction. The hypothesis according to which the shape of the measured gaseous compound or particles concentration curves is of Gaussian type is thus all the more valid.

It is clear that the path according to the invention can have any geometry, provided that the aforementioned constraint relating to the wind direction is verified. The path may in particular have a complex geometry if, at least in the first case stated above, the wind direction is particularly changing during step a).

According to the invention, the concentration of at least one of a gaseous compound and particles of interest is measured for the succession of the determined consecutive positions of the mobile measurement system. It is clear that a measurement time (i.e. a measurement moment) of the mobile measurement system corresponds to any position of the mobile measurement system, while the mobile measurement system is moving. It is clear that the travel speed of the mobile measurement system can be variable or even zero while this step is carried out. Preferably, timestamping of the measures can be carried out in this step in order to know the measurement time corresponding to a measurement position of the mobile measurement system. Advantageously, to facilitate switching from the temporal scale to the spatial scale, a discrete function x(t) associating with any measurement time of the mobile measurement system a position of the mobile measurement system can be created. It is clear that this function is not necessarily bijective insofar as a single position of the mobile measurement system can correspond to several measurement times of the mobile measurement system when the path of the mobile measurement system comprises several passages through the same spatial position. Such a measurement repetition in the same position can be advantageous to improve the redundancy of information, even if the wind direction has changed between the various passages of the mobile measurement system through the same measurement point.

According to an implementation of the invention, the succession of positions of the mobile measurement system can be determined as a function of an instantaneous or average wind direction, but also as a function of a travel speed of the mobile system and of a measurement frequency of the mobile measurement system. In other words, the line segments on which the positions of the measurement points must be located are determined according to an instantaneous or average wind direction, but the positions on these segments are determined as a function of a measurement frequency and of a travel speed of the mobile measurement system. According to an implementation of the invention, the travel speed of the mobile measurement system can range between 10 and 90 km/h, and it is preferably 30 km/h. According to an implementation of the invention, the measurement frequency of the mobile measurement system can range between 0.5 s and 5 s, and it is preferably 1 s. Such travel speed values of the mobile measurement system, preferably combined with such measurement frequencies, enable sufficient sampling of the curves resulting from these measurements.

At the end of this step, at least one curve representative of the evolution of the at least one of the gaseous compound and the particle concentrations as a function of the measurement time of the mobile measurement system along the path, and two curves representative of the evolution of respectively the wind speed and direction as a function of the measurement time of the mobile measurement system along the travel path of the mobile measurement system, are obtained.

Advantageously, in order to reduce the measurement noise present on at least one of the curves thus measured, a filter can be applied to the curve, for example a low-pass filter of IIR (Infinite Impulse Response) type, in particular a Butterworth filter. Advantageously, a 4th order Butterworth filter can be applied to at least one of the measured curves, with a threshold frequency of 1/10 of the Nyquist frequency. Such filters allow elimination of high-frequency oscillations while preserving the slowly varying parts of the signal or, in other words, such filters allow the curves to be smoothed.

Advantageously, if a concentration measurement is carried out for at least one of the gaseous compounds and the particles, a curve representative of the evolution of the gaseous compound or a concentration of particles as a function of the measurement time of the mobile measurement system can be obtained. Subsequently, and for simplification purposes, reference is made to “concentration curves” instead of “curves representative of the evolution of the gaseous compound or particles concentration of particles as a function of the measurement time of the mobile measurement system”.

### 2) Determination of Pairs of Consecutive Minima and Maxima

This step determines, from predefined criteria, all the pairs of a consecutive (i.e. following one another) (local or global) minimum and (local or global) maximum in each of the curves representative of the evolution of at least one of the gaseous compound and concentration of particles as a function of the measurement time of the mobile measurement system. In other words, what is sought is, in each concentration curve, at least one minimum followed by a maximum, or at least one peak preceded by a trough meeting predefined criteria. Such a search can be performed using any algorithm for search of extrema in a curve. Those skilled in the art know of plural algorithms for search of extrema in a curve.

Preferably, in this step, a plural of consecutive pairs of a minimum followed by a maximum of the concentration curve being considered can be determined to improve the redundancy of information as discussed in step 3) hereafter. It is clear that consecutive pairs of a minimum followed by a maximum in a concentration curve can only be determined if the path defined in the previous step passes several times through at least one of the gas and particles plume.

According to the invention, this step is applied to a curve of each of at least one of a gaseous compound and concentration of particles curve as a function of the measurement time of the mobile measurement system. Advantageously, at least one of curves of the gaseous compound and concentration of particles can be filtered prior to carrying out this step, and determination of at least one pair of a consecutive minimum and maximum for this concentration curve can be performed on the filtered curve.

According to an implementation of the invention, the predefined criteria can comprise at least one threshold value that is a function of the measurement error of the measurement system and preferably equal to ten times the measurement error of the measurement system. This threshold value, denoted by Serr hereafter, can then be advantageously used in order to overcome measurement errors when seeking extrema of the concentration curve being considered.

According to another implementation of the invention, the predefined criteria can be determined from two threshold values as a function of the values of the global minimum (denoted by Cmin hereafter) and maximum (denoted by Cmax hereafter) of the concentration curve being considered. According to one embodiment, the first and the second thresholds, denoted by S1ext and S2ext hereafter, are defined as a function of the value of the global minimum and maximum of the concentration curve being considered, according to formulas of the type:

$$S 1 ext = 0.01 * ( C max - C min ) / C max$$

$$and$$

$$S 2 ext = 0.001 * ( C max - C min ) / C max .$$

According to this implementation of the invention, the pairs of a consecutive minimum and maximum of a concentration curve can be determined as follows:
i) browsing the N samples of the concentration curve until one of the samples n verifies the following inequalities:

$$\vert C ( n ) - C ( n - 1 ) \vert < S 1 ext * C ( n )$$

$$and$$

$$C ( n + 1 ) > C ( n ) * ( 1 + S 1 ext )$$

where C(n−1), C(n) and C(n+1) are respectively the concentration measured for sample n−1, sample n and sample n+1. In other words, since the concentration curve can have a plateau, the first index from which the concentration curve begins to increase is sought. Thus, test |C(n)−C(n−1)|<S1ext*C(n) allows expressing that, as long as one is on a plateau of the curve, index n is incremented until the index where the concentration begins to increase is reached, within the relative error S1ext, which is detected by use of the additional test C(n+1)>C(n)*(1+S1ext). A table denoted by nmin is then initialized, with the value of index n verifying this inequality.

Then, one continuation occurs to determine the minima and maxima of the concentration curve being considered, by repeating the following steps:
ii) browsing the N samples of the concentration curve until one of samples n verifies the inequality as follows:

$$C ( n ) > ( 1 + S 2 ext ) * C ( n + 1 )$$

where C(n) and C(n+1) are respectively the concentration measured for sample n and sample n+1. In other words, one seeks an index corresponding to a maximum of the concentration curve, this maximum being chosen by taking account of a maximum slope, which is a function of second threshold S2ext as defined above, between the maximum and the measurement following this maximum in the concentration curve. A table nmax can then be incremented with the value of index n verifying this inequality,
iii) continuing browsing the N samples of the concentration curve until one of samples n verifies the inequality as follows:

$$C ( n + 1 ) > ( 1 + S 2 ext ) * C ( n ) .$$

In other words, an index is sought corresponding to a minimum of the concentration curve, with this minimum being selected by accounting for a maximum slope, which is a function of second threshold S2ext as defined above, between the minimum and the measurement following this minimum in the concentration curve. Table nmin can then be incremented with the value of index n verifying this inequality.

Steps ii) and iii) are repeated by continuing browsing the N samples of the concentration curve to determine all of the NI pairs (nmin (i), nmax (i)) of indices nmin and nmax of the samples corresponding to a minimum and a maximum of the concentration curve being considered.

Advantageously, only the NE pairs consisting of a consecutive minimum and maximum of a given concentration curve for which C(nmax(i))>Cmin+0.05*(Cmax−Cmin), with i ranging from 1 to NI, are kept. That is only the pairs having a maximum of sufficiently great amplitude to be reliably used for determining the position of the emission source are kept. NE denotes hereafter the number of pairs of a consecutive minimum and maximum determined for a given concentration curve with the value of NE being at most NI.

Then, according to the invention, for each of the pairs of a consecutive minimum and maximum of each concentration curve, the position of the mobile measurement system corresponding to the maximum of the pair being considered is determined, as well as a time gap between the measurement time of the mobile measurement system corresponding to the maximum of the pair considered and the measurement time of the mobile measurement system corresponding to the minimum of the pair considered.

Subsequently, for each pair of a consecutive minimum and maximum ne, with n ranging from 1 to NE, the position of the mobile measurement system corresponding to the maximum of the pair being considered is denoted by xₙₑ, and the time gap between the maximum and the minimum preceding the maximum of the pair considered ne is denoted by λₙₑ. According to an implementation of the invention, it can be written xₙₑ=x(tₘₐₓ^{(ne)}) where tₘₐₓ^{(ne)} is the measurement time of the mobile system corresponding to the maximum of the pair considered ne, and function x(t) is the discrete function associating with any measurement time of the mobile measurement system a position of the mobile measurement system described in the previous step.

### 3) Determining the Position of the Emission Source

This step determines, for each gaseous compound or for the particles being considered, the position of at least one of the source emitting the gaseous compound and the particles being considered, from the positions of the mobile measurement system corresponding to the maxima of the NE pairs consisting of a consecutive minimum and maximum, and the time gaps between the maximum and the minimum of the NE pairs being determined in the previous step for the gaseous compound or the particles being considered, as well as average wind speeds and directions between the measurement times of the mobile measurement system corresponding to the minimum and maximum of the NE pairs. In other words, in this step, a position of the source emitting at least one of each gaseous compound and particle being measured is determined. Indeed, in a single geographical zone, there may be several sources emitting at least one of different or the same gaseous compounds and particles. For example, in a geological gas storage site, there may be a leak of THT-odorized natural gas, and a leak from the THT storage tank. If measurements have been carried out for at least one of various gaseous compounds and particles in step 1), it is therefore important to seek the position of the source for each measured compound and particle.

Advantageously, at least the wind direction curve or the wind speed curve has been filtered prior to carrying out this step, and determination of the average wind direction and speed between the times corresponding to the minimum and maximum of the NE pairs is performed on the filtered curve(s).

According to an implementation of the invention, the position of the source emitting a at least one of gaseous compound and particles, denoted by x₀ hereafter, can be written as

$${x}_{0} = \frac{{\sum }_{ne = 1}^{NE} ( {x}_{ne} - {λ}_{ne} \vec{{v}_{ne}} )}{NE} \qquad ( 1 )$$

where NE is the number of pairs of a consecutive minimum and maximum, xₙₑ is the position of the mobile measurement system corresponding to the maximum of pair ne, λₙₑ is the time gap between the maximum and minimum of pair ne, and \vec{v}ₙₑ is a vector oriented in the average wind direction between the measurement times of the mobile measurement system corresponding to the minimum and maximum of pair ne and whose norm is the average wind speed between the measurement times of the mobile measurement system corresponding to the minimum and maximum of pair ne. In other words, according to this implementation, the position of the source emitting the gaseous compound or the particles being considered can be determined from an average of intermediate positions x_{0,ne} determined for each pair ne according to a formula written as:

$${x}_{0 , ne} = ( {x}_{ne} - {λ}_{ne} \vec{{v}_{ne}} ) . \qquad ( 2 )$$

This formula expresses that an intermediate position for a given pair ne can be obtained by translation of the position of the mobile measurement system corresponding to the maximum of pair ne, with this translation being a function of the average of the speed vector over the time interval between the minimum and maximum of the pair, and of the time for the mobile measurement system to pass through the plume until it reaches the measurement point corresponding to a concentration maximum. It is clear that the intermediate positions allows a redundancy of information relating to the position of the source emitting at least one of the gaseous compound and the particles, and that the average of the intermediate positions make possible to attenuate the impact of errors related to measurements (concentration, wind direction and speed) and the impact of errors related to the hypotheses leading to Equation (2) above relative to the intermediate positions.

The main hypotheses leading to Equation (2) above are as follows:
the wind is direction and speed invariant over the time interval between the minimum and maximum of a pair (hypothesis of stationarity), and
the measurement is performed perpendicular to the main wind direction.

Thus, at the end of this step, a position is obtained for the source emitting at least one of each gaseous compound and particles measured in step 1). It is clear that, in most cases, the positions determined for each compound/particle are close to one another. According to an implementation of the invention, if the relative difference between source positions determined for at least one of two different gaseous compounds and particles is less than 5%, it may be considered that it is the same emission source for both at least one of gaseous compounds and particles. The position of the source of these two gaseous compounds can then be obtained by averaging the two positions. Otherwise, it is considered that there are two different sources.

### 4) Determining Additional Characteristics for the Emission Source

According to an implementation of the invention, it is possible to further determine at least one additional characteristic relating to the source emitting at least one of a gaseous compound and particles.

According to an implementation of the invention wherein the additional characteristic relating to the source emitting at least one of a gaseous compound and particles is the diffusion coefficient with the diffusion coefficient relating to the source emitting a gaseous compound or particles, denoted by k₀ hereafter, can be determined with a formula of the type:

$${k}_{0} = \frac{1}{NE} {\sum }_{ne = 1}^{NE} {k}_{ne} = \frac{1}{NE} {\sum }_{ne = 1}^{NE} \frac{{d}_{ne}^{2}}{2 {λ}_{ne}}$$

where [symbol] is an intermediate diffusion coefficient determined for pair ne, and [symbol] is the distance between the maximum and minimum of pair ne.

According to an implementation of the invention wherein the additional characteristic relating to the source emitting at least one of a gaseous compound and particles is the flow rate of the emission source with the flow rate relating to the source emitting a gaseous compound or particles, denoted by Q₀ hereafter, can be determined with a formula written as:

$${Q}_{0} = \frac{3 \sqrt{π}}{NE} ( {C}_{max} - {C}_{min} ) {\sum }_{ne = 1}^{NE} \vert \vec{{v}_{ne}} \vert$$

where Cₘₐₓ and Cₘᵢₙ are respectively the global maximum and minimum of the concentration curve.

According to a preferred implementation of the method of the invention, at least steps 2) and 3) (and optionally step 4)) of the method of the invention can be applied in parallel to step 1). In other words, the position of the source emitting at least one of a gaseous compound and particles can be determined in real time, as the mobile measurement system is moving. More precisely, for each position of the mobile measurement system in step 1), determination of a pair of a consecutive minimum and maximum in the measured curve up to the current position of the mobile measurement system is desired, and if a pair is determined, the position of the source emitting at least one of a gaseous compound and particles is determined from this pair and from any pair determined for previous positions of the mobile measurement system.

It is clear that the method according to the invention comprises steps carried out by means of an equipment (a computer workstation for example) comprising data processing (processor) and data storage (a memory, in particular a hard drive), as well as an input/output interface for data input and results output.

In particular, the data processing is configured to carry out at least steps 2) and 3) described above, and optional step 4).

Furthermore, the invention concerns at least one of a computer program product downloadable from a communication network, recorded on a computer-readable medium and a processor for executing, program code instructions for carrying out at least steps 2) and 3), and optionally step 4), described above, when the program is executed on a computer.

### EXAMPLES

The features and advantages of the method according to the invention will be clear from the application example hereafter.

The method according to the invention was implemented in order to locate the source of a natural gas leak in a geographical zone close to a geological gas storage site. For this illustrative example, the gas emitting source has a known position since it is a leak from a gas tank.

Step 1) of the method according to the invention was carried out by use of an embodiment of the system and of the method described in patent application EP-3,901,604, in order to measure the concentration of methane, ethane, carbon dioxide and THT (odorant molecule added to methane for safety reasons) present in the ambient air. The measurement system described in this application is arranged on board a vehicle, the UV and IR sensors, as well as the light source, being arranged on the vehicle roof, the means for processing and analyzing the digital signals from these sensors being arranged inside the vehicle.

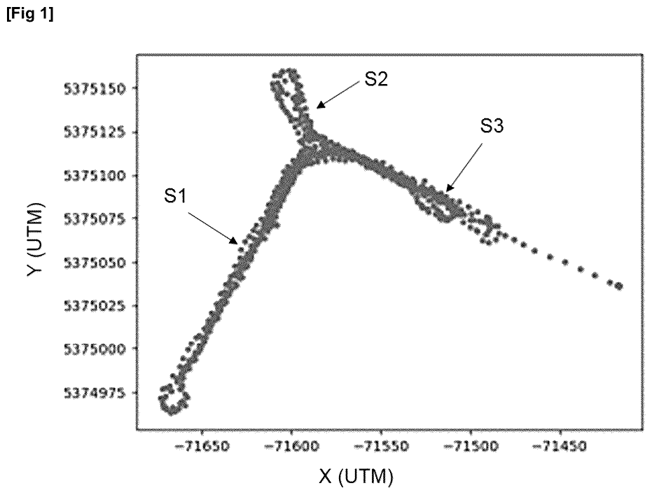

By using the mobile measurement system, concentrations of the THT molecule, of methane, of ethane and of carbon dioxide in the ambient air were measured every second according to a path determined in relation to the instantaneous wind direction, as described above, and also according to the infrastructures (trails, roads) on which the vehicle carrying the measurement system travels. The geographical coordinates X and Y (in UTM coordinates) of the mobile measurement system along the travel path used for this application example are shown in FIG. 1. It is observed that this path comprises several passages through close geographical positions (almost superimposed positions), globally distributed along three line segments S1, S2 and S3 (in other words, the mobile measurement system makes several round trips along three line segments).

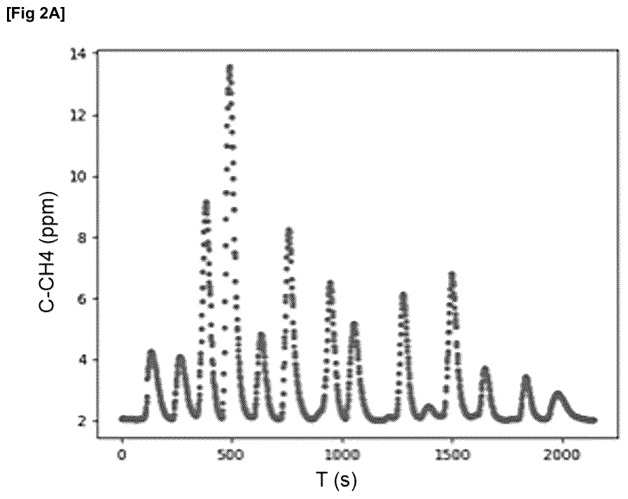

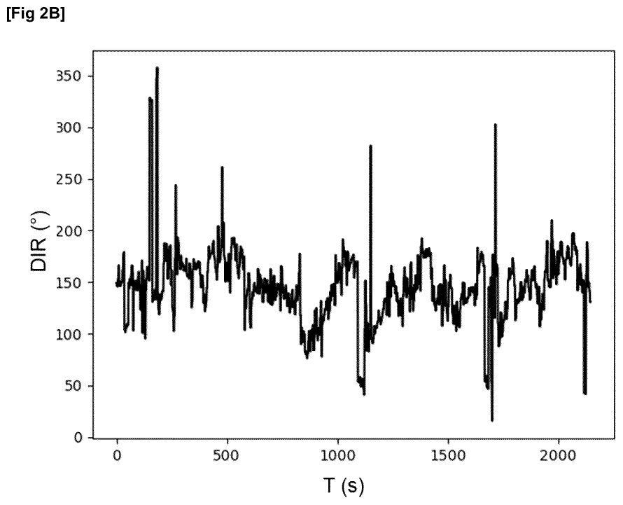

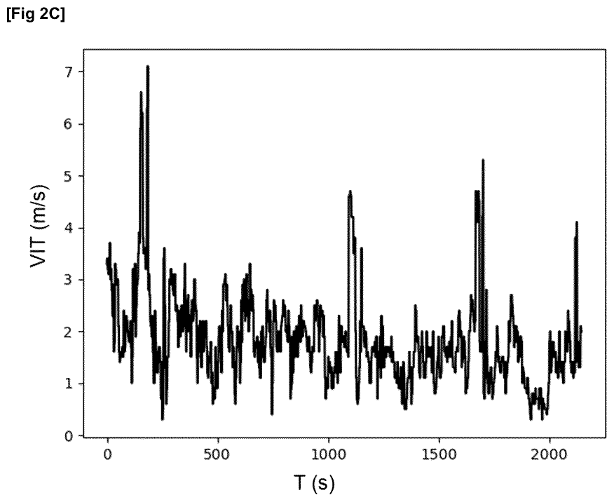

FIG. 2A illustrates the evolution of the measured methane concentration C—CH4 as a function of time T along the path traveled by the mobile measurement system shown in FIG. 1. It is observed that this curve comprises plural concentration peaks, which verify the fact that the path of the mobile measurement system comprises several passages through the gas plume. FIG. 2B and FIG. 2C respectively show the curves of the evolution of wind direction DIR and of wind speed VIT measured as a function of time T along the path of the mobile measurement system presented in FIG. 1. It is observed that the wind direction can be particularly changing during the measurement.

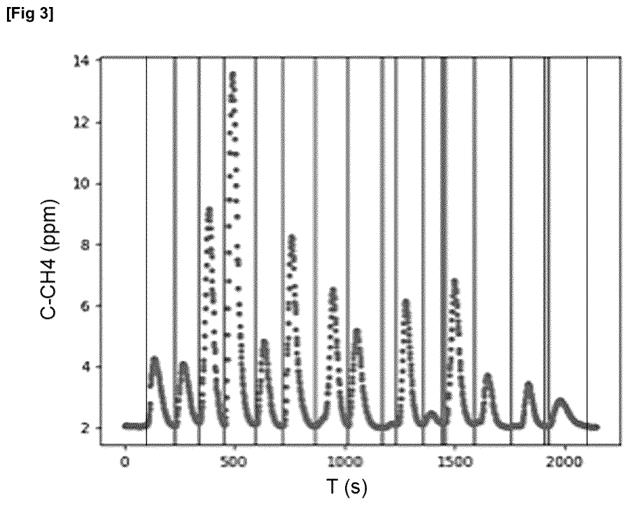

Applying step 2) of the method according to the invention has led to the identification of 15 pairs of a consecutive minimum and maximum according to the invention, contained between a minimum and a maximum. FIG. 3 shows the CH4 concentration curve C—CH4 of FIG. 2A wherein the vertical lines correspond to the 15 identified minima, each minimum being followed by a maximum of CH4 concentration curve C—CH4.

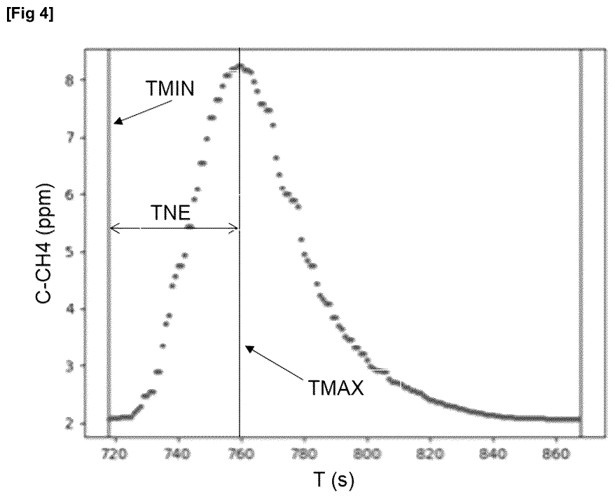

Then, according to the invention, for each pair determined, the position of the mobile measurement system corresponding to the maximum of the pair considered is determined, as well as a time gap between the measurement time of the mobile measurement system corresponding to the maximum of the pair and the measurement time of the mobile measurement system corresponding to the minimum of the pair. FIG. 4 shows an enlargement of a portion of FIG. 3 comprising a pair of a consecutive minimum and maximum, and it shows the time gap TNE between the maximum (at time TMAX) and the minimum (at time TMIN) preceding the maximum of this pair.

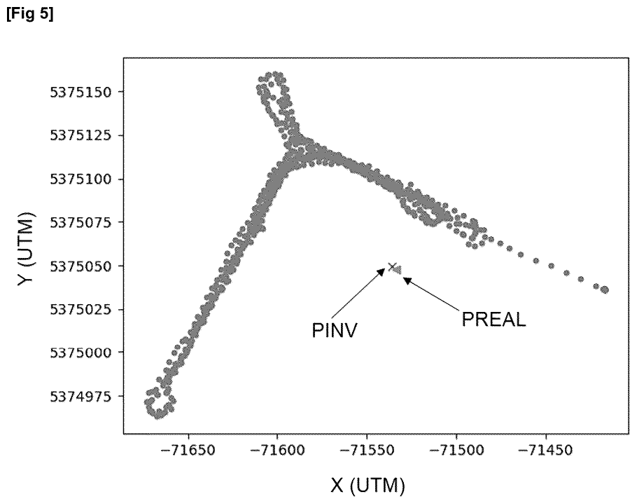

FIG. 5 returns to FIG. 1 and additionally shows the position PINV of the gas leak source determined with the method according to the invention, in form of a cross, and the real position PREAL of the gas emitting source, in form of a triangle. More precisely, the UTM coordinates of the leaking point determined with the method according to the invention are (−71535.843, 5375049.606), while the UTM coordinates of the real leaking point are (−71533.905, 5375047.433). Thus, for this application example, the error on the position of the gas emitting source of the method according to the invention is only 2.9 m. Furthermore, this result was obtained in less than 2 hundredths of a second with an Intel® Xeon® CPU E5-1620 v3 @ 3.50 GHz type processor.

The method according to the invention thus allows accurate and reliable determination of the position of a gas emitting source in a geographical zone. In addition, the method according to the invention is faster and easier to implement than methods of the prior art as it requires no complex calculations such as the solution of an inverse problem, which is very computing time and memory consuming. It is thus possible to implement the method according to the invention in an on-board manner and in real time.

1-8. (canceled)

9. A method for determining position of a source emitting at least one of a gaseous compound and particles in a geographical area, using a mobile measurement system comprising at least one sensor for measuring at least one of a concentration of the gaseous compound and the particles and a sensor for measuring a wind speed and direction, comprising steps of:
a) measuring the concentration of the at least one gaseous compound and the particles, the wind speed and the wind direction for a succession of positions of the mobile measurement system forming a travel path of the mobile measurement system in the geographical zone, each of the positions corresponding to a measurement time of the mobile measurement system, the positions of the succession of positions of the mobile measurement system being determined so that each of segments between two consecutive positions of the succession of positions of the mobile measurement system form an angle of between 45° and 135° with an instantaneous or average wind direction resulting from the measured wind direction, and obtaining a first curve representative of evolution of the concentration for each of the at least one gaseous compounds and particles as a function of measurement time of the mobile measurement system, and second and third curves respectively representative of the evolution of the wind speed and direction as a function of the measurement time of the mobile measurement system;
b) from predefined criteria, for each of the first curves, determining at least one pair of a consecutive minimum and maximum of the first curve, and for each of the pairs of each of the first curves, determining a position of the mobile measurement system corresponding to the maximum of the pair and a time gap between a measurement time of the mobile measurement system corresponding to the maximum of the pair and a measurement time of the mobile measurement system corresponding to the minimum of the pair; and
c) for each of at least one of the gaseous compound and the particles, determining the position of the emission source of at least one of the gaseous compound or the particles in the geographical zone from the positions of the mobile measurement system corresponding to the maximum of the pairs being determined for the gaseous compound or the particles, the time gaps between the maximum and minimum of the pairs determined for the gaseous compound or the particles, and of the average wind speeds and the directions between the measurement times of the mobile measurement system corresponding to the minimum and maximum of the pairs.

10. A method as claimed in claim 9, wherein the position x₀ of the source emitting a gaseous compound or particles is determined with a formula expressed as:
$${x}_{0} = \frac{{\sum }_{ne = 1}^{NE} ( {x}_{ne} - {λ}_{ne} \vec{{v}_{ne}} )}{NE}$$
where NE is a number of the pairs determined, xₙₑ is the position of the mobile measurement system along the path corresponding to the maximum of the pair ne, λₙₑ is the time gap between the maximum and minimum of the pair ne, and \vec{v}ₙₑ is a vector oriented in the average wind direction between the measurement times of the mobile measurement system corresponding to the minimum and maximum of the pair ne, a norm is the average wind speed between the measurement times of the mobile measurement system corresponding to the minimum and maximum of the pair ne.

11. A method as claimed in claim 9, wherein an angle formed between the segment between the first and second positions of the pair of consecutive positions of the path and the wind direction measured for the first position of the pair, or the average wind direction measured prior to step a), ranges between 80° and 100°.

12. A method as claimed in claim 11, wherein the formed angle is 90°.

13. A method as claimed in claim 12, wherein the formed angle is 90°.

14. A method as claimed in claim 13, wherein the formed angle is 90°.

15. A method as claimed in claim 9, wherein, at an end of step a), a Butterworth filter is applied to at least one of the first, second and third curves, and at least one of steps b) and c) are applied from at least one of the first, second and third filtered curves.

16. A method as claimed in claim 10, wherein, at an end of step a), a Butterworth filter is applied to at least one of the first, second and third curves, and at least one of steps b) and c) are applied from at least one of the first, second and third filtered curves.

17. A method as claimed in claim 11, wherein, at an end of step a), a Butterworth filter is applied to at least one of the first, second and third curves, and at least one of steps b) and c) are applied from at least one of the first, second and third filtered curves.

18. A method as claimed in claim 12, wherein, at an end of step a), a Butterworth filter is applied to at least one of the first, second and third curves, and at least one of steps b) and c) are applied from at least one of the first, second and third filtered curves.

19. A method as claimed in claim 13, wherein, at an end of step a), a Butterworth filter is applied to at least one of the first, second and third curves, and at least one of steps b) and c) are applied from at least one of the first, second and third filtered curves.

20. A method as claimed in claim 9, wherein the predefined criteria of the first curve are formed from a first and a second threshold value S1ext and S2ext defined with formulas:
$$S 1 ext = 0.01 * ( C max - C min ) / C max$$
$$and$$
$$S 2 ext = 0.001 * ( C max - C min ) / C max$$
wherein Cmin and Cmax are respectively global minima and maxima of the first curve.

21. A method as claimed in claim 20, wherein all of the pairs of a consecutive minimum and maximum of the first curve are determined as follows:
i) browsing N samples of the first curve until one of the samples n verifies the inequalities as follows:
$$\vert C ( n ) - C ( n - 1 ) \vert < S 1 ext * C ( n )$$
$$and$$
$$C ( n + 1 ) > C ( n ) * ( 1 + S 1 ext )$$
where C(n−1), C(n) and C(n+1) are respectively the concentration measured for sample n−1, sample n and sample n+1, and initializing a table nmin with the index n;
ii) continuing browsing of the N samples of the first curve until one of the samples n verifies an inequality as follows:
$$C ( n ) > ( 1 + S 2 ext ) * C ( n + 1 )$$
and incrementing a table nmax with the index n; and
iii) continuing browsing of the N samples of the first curve until one of the samples n verifies the inequality as follows:
$$C ( n + 1 ) > ( 1 + S 2 ext ) * C ( n )$$
and incrementing the table nmin with the index n,
and repeating steps ii) and iii) by continuing browsing of the N samples of the curve to determine all the NI pairs (nmin (i), nmax (i)) of the indices nmin (i) and nmax (i) of the samples corresponding to a minimum and a maximum of the first curve, with i ranging from 1 to NI.

22. A method as claimed in claim 21, wherein only the NE pairs of a minimum followed by a maximum of the first curve for which C(nmax(i))>Cmin+0.05*(Cmax−Cmin), with i ranging from 1 to NI, with NE≤NI, are kept.

23. A computer program product downloadable from a communication network, recorded on a computer-readable medium, and at least one of processor executable, comprising program code instructions for carrying out at least steps b) and c) of the method as claimed in claim 9, when the program is executed on a computer.
